(19) United States
(12) Patent Application Publication
(10) Pub. No.: US 2019/0301984 A1
(43) Pub. Date: Oct. 3, 2019

(54) MAGNETIC WET BENCHES WITH AUTOMATED SAMPLE COLLECTION

(71) Applicant: ILLINIOS TOOLWORKS INC., Glenview, IL (US)

(72) Inventors: Sakif Bin Ferdous, Skokie, IL (US); Wyatt M. Burns, Woodridge, IL (US); David John Fry, Evanston, IL (US)

(21) Appl. No.: 16/365,944

(22) Filed: Mar. 27, 2019

Related U.S. Application Data
(60) Provisional application No. 62/648,655, filed on Mar. 27, 2018.

(51) Int. Cl. G01N 1/31

(52) U.S. Cl. CPC G01N 1/31; G01N 2001/317

(57) ABSTRACT

Systems and methods are provided for implementing and utilizing magnetic wet benches with automated sample collection.

### CLAIM OF PRIORITY

This patent application makes reference to, claims priority to and claims benefit from U.S. Provisional Patent Application Ser. No. 62/648,655, filed on Mar. 27, 2018, The above identified application is hereby incorporated herein by reference in its entirety.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research, Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

In some instances, dedicated material and/or products may be used in non-destructive testing. For example, non-destructive testing of particular type of articles may entail applying (e.g., by spraying on, pouring into, passing through, etc.), to the would-be tested article or part, a material that is configured for performing the non-destructive testing. In this regard, such material (referred as “NDT material” or “NDT product” hereinafter) may be selected and/or made based on having particular magnetic, visual, etc. characteristics suitable for the non-destructive testing—e.g., allowing detecting defects and imperfections in the would-be tested article.

In some instances, it may be desirable to assess the NDT material prior to start of testing or inspection. However, conventional approaches for assessing certain NDT material used in particular non-destructive testing methods, if any existed, may be cumbersome, inefficient, and/or costly.

Further limitations and disadvantages of conventional approaches will become apparent to one management of skill in the art, through comparison of such approaches with some aspects of the present method and system set forth in the remainder of this disclosure with reference to the drawings.

### BRIEF SUMMARY

Aspects of the present disclosure relate to product testing and inspection. More specifically, various implementations in accordance with the present disclosure are directed to magnetic wet benches with automated sample collection, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example magnetic wet bench with automated sample collection, in accordance with aspects of the present disclosure.

FIG. 2 illustrates an example controller for use in support of automated sample collection, in accordance with aspects of the present disclosure.

FIG. 3 illustrates a flowchart of an example process for utilizing magnetic wet bench with automated sample collection, in accordance with aspects of the present disclosure.

### DETAILED DESCRIPTION

Various implementations in accordance with the present disclosure are directed to providing enhanced and optimized ways for utilizing magnetic wet bench, particularly with respect to sample collection performed therein.

An example system, configured for magnetic non-destructive testing (NDT) inspection, in accordance with the present disclosure, may include a container that stores non-destructive testing (NDT) magnetic solution; an application system for applying the NDT magnetic solution during inspection; a sample collection device; and one or more circuits configured to power on the system at a pre-set start time; initiate agitation of the NDT magnetic solution for a pre-set agitation duration; and trigger collection of a sample from the NDT magnetic solution into the sample collection device. The system may be a magnetic wet bench.

In an example implementation, the application system may include a hose system and a pump, with the pump being configured for pumping the NDT magnetic solution through the hose system.

In an example implementation, the hose system may include a diverter that diverts the sample into the sample collection device.

In an example implementation, the one or more circuits may be configured to activate the pump, after end of the pre-set agitation duration, to initiate pumping of the NDT magnetic solution through the hose system.

In an example implementation, the system may include an extraction system that delivers the sample of the NDT magnetic solution into the sample collection device.

In an example implementation, the one or more circuits may be configured to cause collection of the sample to meet a particular pre-set volume.

In an example implementation, the one or more circuits may be configured to provide an indication when the sample may be ready for analysis.

In an example implementation, the one or more circuits may be configured to provide the indication after the sample settles for a pre-set settling duration.

In an example implementation, the one or more circuits may be configured to determine one or more timing parameters for controlling sample collection based on a pre-defined schedule.

An example method for automated sample collection in a system configured for a magnetic non-destructive testing (NDT) inspection, in accordance with the present disclosure, may include powering on the system at a pre-set start time; initiating agitation of non-destructive testing (NDT) magnetic solution for a pre-set agitation duration, with the NDT magnetic solution being stored within a container in the system: and triggering collection of a sample from the NOT magnetic solution into a sample collection device.

In an example implementation, the system may include a hose system configured for delivering the NOT magnetic solution, and the triggering of the collection of the sample may include diverting the sample via the hose system into the sample collection device.

In an example implementation, the system may include a pump configured for pumping the NDT magnetic solution, and the triggering of the collection of the sample including activating the pump, after end of the pre-set agitation duration, to initiate pumping of the NDT magnetic solution.

In an example implementation, the collection of the sample may be configured to ensure that the samples meet a particular pre-set volume.

In an example implementation, an indication when the sample may be ready for analysis may be provided. The indication may be provided based on a one or more indication conditions. The one or more indication conditions may include the sample settling for a pre-set settling duration.

In an example implementation, one or more timing parameters for controlling sample collection may be determined based on a pre-defined schedule.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code, Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”, As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

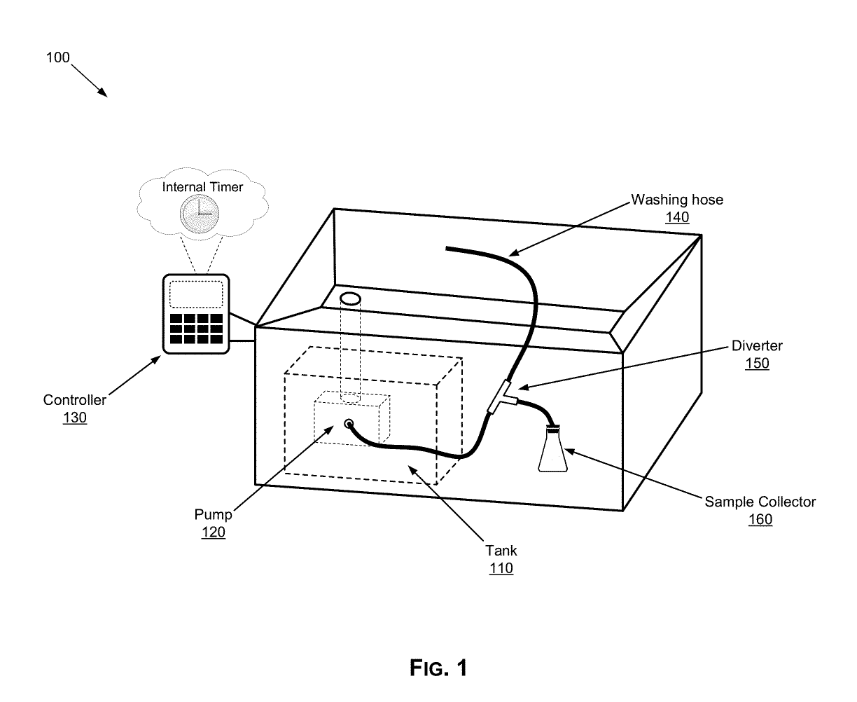

FIG. 1 illustrates an example magnetic wet bench with automated sample collection, in accordance with aspects of the present disclosure. Shown in FIG. 1 is a magnetic wet bench 100.

Magnetic particle inspection stationary wet benches (or magnetic wet benches), such as the magnetic wet bench 100, are configured for use in NDT magnetic-particle inspections, such as of a variety of components (e.g., machine parts, etc.), A typical magnetic wet bench has an engagement component (e.g., head and tail stocks) with electrical contacts, to engage the part being tested (e.g., with part clamped therebetween, with one of the engagement parts, such as the tail stock being moved and locked into place to accommodate parts of various lengths). The testing may entail inducing magnetic fields in the part, such as via direct magnetization by applying current via the electrical contacts of the engagement components. Various systems may utilize various options for magnetizing the to-be-tested parts, with some systems allowing for selecting among such options. For example, operators may have the option to use AC (alternating current), half wave DC (direct current), or full wave DC (direct current). In some systems, a demagnetization function is built into the system. The demagnetization function may utilize a coil and decaying AC (alternating current).

During inspection, a wet magnetic particle solution is applied to the part. The particle solution (also called “bath”) may comprise visible or fluorescent particles that may be magnetized. The particle solution may be collected and held in a tank 110, with a pump 120 pumping the bath through a hose system 140, which is used to apply the particle solution to the parts being inspected—e.g., with the hose system 140 having a nozzle that is used in spraying the parts. The magnetic wet bench 100 may also incorporate a controller unit 130 to allow operators to control the system and/or inspections. In this regard, the controller unit 130 may comprise suitable circuitry and input/output components.

In an example inspection use scenario, the part is engaged (e.g., clamped between two electrical contacts), and the magnetic solution is applied to (e.g., flowed over) the surface of the part. The bath is then interrupted and a magnetizing current is applied to the part. The magnetizing current may be applied for only a short duration, and precautions may be taken to prevent burning or overheating of the part. A magnetic field is created in the part (e.g., a circular field flowing around the circumference of the part) as a result of applying the magnetizing current to the part via the electrical contacts. With the part wet from the magnetic solution, defects such as cracks may be detected, as a result of leakage fields from these defects, which attract the particles to form indications.

Existing systems may have some shortcomings, however. For example, currently, operators may need to analyze the magnetic solution (or bath), to ensure that the tests are accurate, the bath needs to be within a specific range of particle concentration, before starting inspections. In this regard, operators need to manually power on the machine and start agitating the bath to get the magnetic particles properly mixed, and then collect a bath sample for analysis and verification of the proper particle concentration. The operators must follow particular guidelines and requirements in doing so, however.

For example, in accordance with ASTM and NADCAP NDT specifications, operators have to first agitate the bath for some time—typically, for 30 minutes, before taking a sample. The operator may then analyze the sample, but only after letting it settle for some time—typically, for 60 minutes for an oil bath. Thus, typically operators spend about 1.5 hours ensuring the system is ready, before starting actual inspections.

Accordingly, in various implementations in accordance with the present disclosure, magnetic wet benches may incorporate automated sample collection solutions, to ensure that the sample is collected by intended operation start time, resulting in reduction of non-operational time, labor cost savings, and process control improvements. In this regard, with automated sampled collection, one or more of the required actions associated with the collection of samples are performed automatically—that is, independent of and without requiring interaction by an operator or a user of the system. Automating the sample collection may result in significant time savings (e.g., 1.50 hours of man hours a day), such as by ensuring that sample is collected and ready for analysis and recorded by the time the operator is to start inspection—e.g., at the start of every shift. The automated sample collection solutions may also decrease the chance of human error and increase the reliability of the results.

In the non-limiting example implementation shown in FIG. 1, the magnetic wet bench 100 incorporates an integrated sample collection and measuring device (also referred as “sample collection device”) 160. In this regard, the sample collection device 160 may be added into the machine as a permanent connecting tool. Alternatively, the sample collection device 160 may be configured as independent (e.g., portable) tool that may be applied/connected to (or removed from) magnetic wet benches—e.g., being adding when the automated sample collection is being utilized.

The sample collection device 160 may be configured to collect the bath sample, and to (optionally) measure the particle concentration. The hose system 140 may be (re-)configured and/or adjusted to allow for sample collection, using the sample collection device 160. For example, as shown in FIG. 1, the hose system 160 may incorporate a diverter 150 (e.g., a controllable split channel), which may be configured for splitting and/or diverting bath pushed by the pump 120 for internal collection (e.g., via the sample collection device 160) and/or for applying to the parts (e.g., sprayed via nozzle of the hose system).

The disclosure is not so limited, however, and in some implementations other approaches for extracting the sample and/or delivering to the sample collection devices may be used. For example, in one example implementation, the diverter 150 is not used—i.e., is omitted. Instead, the hose system 140 is used to deliver the sample to the sample collection device 160. In another example implementation, a separate extraction component—i.e., different from the hose system 140, may be used in obtaining the sample after completion of the agitation of the magnetic solution. This separate extraction component may also be connected to, and/or fed by the pump 120; or may alternatively use other means for facilitating the collection of the sample from the tank 110 and delivering the sample to the sample collection device 160.

The collection related component and/or functions may be controlled internally, such as via the controller unit 130, which may control the flow of bath via the hose system 140, such as by controlling pump 120 (e.g., control when to pump the bath into the hose system 140) and/or the diverting of the bath via the diverter 140.

In an example implementation, the controller unit 130 may incorporate an “internal timer” control module, which may be a hardware component (e.g., control circuit), a software unit, or a combination thereof, that will be added to the controller unit 130. The internal timer control may be configured to control the timing the of the collection functions. In this regard, the internal timer control may turn on the machine at particular time, start the bath agitation for a set time, collect a desired volume of a bath sample by diverting flow, and track settling time, such as by executing these tasks in accordance with a predetermined schedule.

For example, in an example use scenario corresponding to the non-limiting implementation illustrated in FIG. 1, the machine may be automatically started (e.g., by the controller unit 130, or a module executed therein) at a set time, and the bath agitation may then be begun and run for set time (e.g., 30 minutes), Then after the agitation time expires, a sample of the bath may be collected and delivered to the sample collection device 160. For example, the agitated bath may be pumped (e.g., using the pump 120) through the hose system 140, and the sample may be taken by diverting the bath from the same hose system 140 into the sample collection device 160, In this regard, the pumping and the diverting may be controlled in a manner to meet pre-set sample volume requirement—e.g., the diverting may be done for a predetermined period time to collect a specific volume of the bath. For example, diverter 150 may be controlled by the controller unit 130, such that the diverting is performed to meet such requirements. Alternatively, the diverter 150 may be controlled by other means—e.g., a suitable pneumatic system. Once the sample is collected, a settling time may be started, such as to ensure that the bath concentration settles for pre-set time (e.g., for 60 minutes), In some instances, an indication may be provided to the operator indicating when the sample is ready for examination.

In some instances, various aspects of the integrated sample collection mechanism may be customized by the operator. For example, in some implementations, timing information (e.g., start time, pre-set timers for various steps, etc.) related to the integrated sample collection mechanism may be customized by the operator, thus allowing the operator to control when the machine is turned/powered on, when to start the bath agitation (e.g., via pump 120), when to collect (and, optionally, the exact volume of) the bath sample, and/or how long to let the sample settle.

In some instances, this timing relating parameters may be made available (e.g., visible) to the operator and alert them when it is time to check the magnetic particle bath concentration. Once set up, this machine will routinely start bath agitation and collect samples to adhere to any specification that the owner desires to meet, while reducing the human involvement in the process.

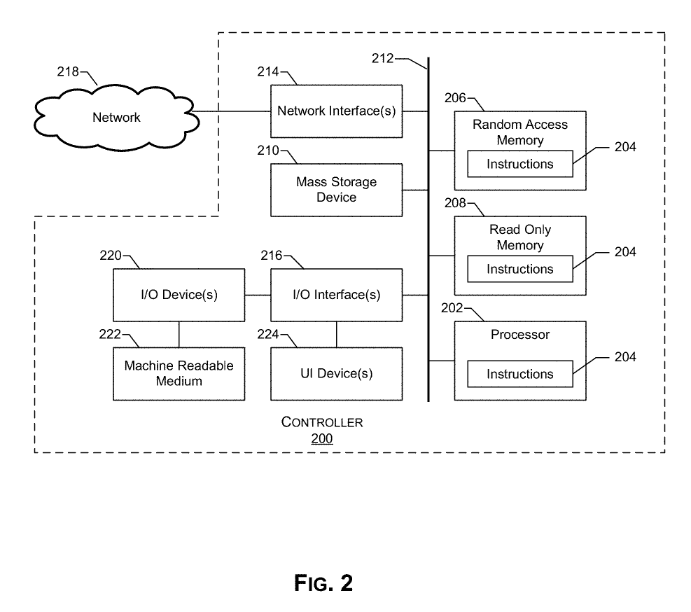

FIG. 2 illustrates an example controller for use in support of automated sample collection, in accordance with aspects of the present disclosure. Shown in FIG. 2 is a controller system 200.

The controller system 200 may comprise suitable circuitry for implementing various aspects of the present disclosure, particularly for supporting automated sample collection in magnetic wet benches, as described with respect to FIG. 1. In this regard, the controller system 200 may represent an example implementation of the controller unit 130 of FIG. 1.

As shown in FIG. 2, the controller system 200 may include a processor 202, In this regard, the example processor 202 may be any general purpose central processing unit (CPU) from any manufacturer. In some example implementations, however, the processor 202 may include one or more specialized processing units, such as RISC processors with an ARM core, graphic processing units, digital signal processors, and/or system-on-chips (SoC).

The processor 202 executes machine readable instructions 204 that may be stored locally at the processor (e.g., in an included cache or SoC), in a random access memory (RAM) 206 (or other volatile memory), in a read only memory (ROM) 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output (I/O) interface 216.

The example network interface 214 includes hardware, firmware, and/or software to connect the controller system 200 to a communications network 218 such as the Internet. For example, the network interface 214 may include IEEE 202.X-compliant wireless and/or wired communications hardware for transmitting and/or receiving communications.

The example I/O interface 216 of FIG. 2 includes hardware, firmware, and/or software to connect one or more user interface devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface.

The example controller system 200 includes a user interface device 224 coupled to the I/O interface 216, The user interface device 224 may include one or more of a keyboard, a keypad, a physical button, a mouse, a trackball, a pointing device, a microphone, an audio speaker, an optical media drive, a multi-touch touch screen, a gesture recognition interface, and/or any other type or combination of types of input and/or output device(s). While the examples herein refer to a user interface device 224, these examples may include any number of input and/or output devices as a single user interface device 224. Other example I/O device(s) 220 an optical media drive, a magnetic media drive, peripheral devices (e.g., scanners, printers, etc.), and/or any other type of input and/or output device.

The example controller system 200 may access a non-transitory machine readable medium 222 via the I/O interface 216 and/or the I/O device(s) 220, Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

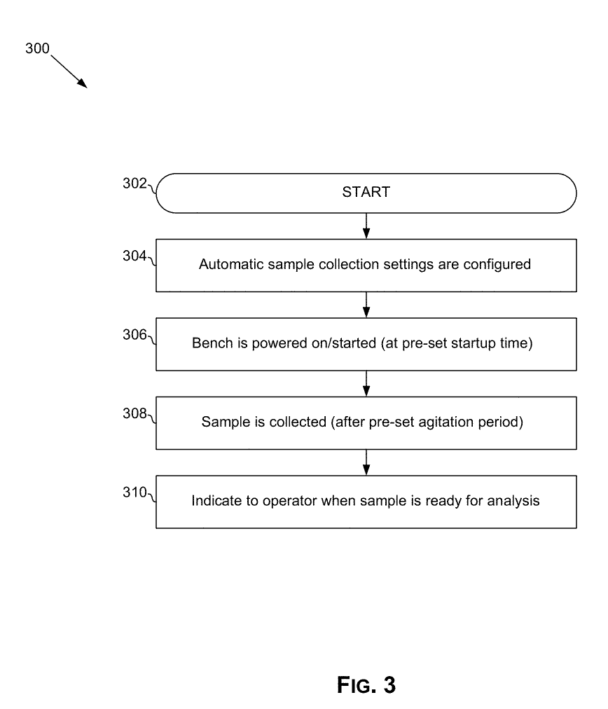

FIG. 3 illustrates a flowchart of an example process for utilizing magnetic wet bench with automated sample collection, in accordance with aspects of the present disclosure. Shown in FIG. 3 is flow chart 300, comprising a plurality of example steps (represented as blocks 302-310), which may be performed in and/or using a suitable system (e.g., magnetic wet bench of FIG. 1), in accordance with the present disclosure.

After start step 302, in which the machine is setup and configured for operation, automatic sample collection settings are configured in step 304. Configuring automatic sampling collection settings may comprise activating automated collection functions, setting or adjusting collections related parameters (e.g., timing information, sample related information like volume, etc.), and/or user preferences (if any), such as whether or not to indicate when collection is complete, etc. The operator may also simply select from various available schedules, which may be pre-defined (such in accordance with particular standards, use environments, etc.).

In step 306, the machine (the magnetic wet bench) is started/powered on based on corresponding pre-set criteria (e.g., at pre-set startup time).

In step 308, a sample is collected based on corresponding pre-set collection criteria—e.g., after pre-set agitation period, with the sample meeting a particular volume requirement. In this regard, the collection may be performed by controlling the bath application components (e.g., pump, hose system, diverting means, etc.) in the machine.

In step 310, an indication to operator may be made when the sample is ready for analysis. For example, the sample may be allowed to settle based on a pre-set timer, and when the timer expires an indication (e.g., visual, audible, etc.) is made to notify the operator that the sample is ready for examination.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A magnetic wet bench, comprising:
a container configured to store non-destructive testing (NOT) magnetic solution;
an application system configured to apply the NOT magnetic solution during inspections;
a sample collection device; and
one or more circuits configured to:
power on the magnetic wet bench at a pre-set start time;
initiate agitation of the NOT magnetic solution for a pre-set agitation duration; and
trigger collection of a sample from the NOT magnetic solution into the sample collection device.

2. The magnetic wet bench of claim 1, comprising an extraction system that delivers the sample of the NOT magnetic solution into the sample collection device.

3. The magnetic wet bench of claim 1, wherein the application system comprises a hose system and a pump, the pump being configured for pumping the NOT magnetic solution through the hose system.

4. The magnetic wet bench of claim 3, wherein the hose system comprises a diverter that diverts the sample into the sample collection device.

5. The magnetic wet bench of claim 3, wherein the one or more circuits are configured to activate the pump, after end of the pre-set agitation duration, to initiate pumping of the NOT magnetic solution through the hose system.

6. The magnetic wet bench of claim 1, wherein the one or more circuits are configured to cause collection of the sample to meet a particular pre-set volume.

7. The magnetic wet bench of claim 1, wherein the one or more circuits are configured to provide an indication when the sample is ready for analysis.

8. The magnetic wet bench of claim 7, wherein the one or more circuits are configured to provide the indication after the sample settles for a pre-set settling duration.

9. The magnetic wet bench of claim 1, wherein the one or more circuits are configured to determine one or more timing parameters for controlling sample collection based on a pre-defined schedule.

10. A method for automated sample collection in a magnetic wet bench, the method comprising:
powering on the magnetic wet bench at a pre-set start time;
initiating agitation of non-destructive testing (NDT) magnetic solution for a pre-set agitation duration, wherein the NDT magnetic solution is stored within a container; and
triggering collection of a sample from the NDT magnetic solution into a sample collection device.

11. The method of claim 10, wherein the magnetic wet bench comprises a hose system configured for delivering the NDT magnetic solution, and wherein triggering the collection of the sample comprises diverting the sample via the hose system into the sample collection device.

12. The method of claim 10, wherein the magnetic wet bench comprises a pump configured for pumping the NDT magnetic solution, and wherein triggering the collection of the sample comprising activating the pump, after end of the pre-set agitation duration, to initiate pumping of the NDT magnetic solution.

13. The method of claim 10, comprising configuring the collection of the sample to ensure that the samples meet a particular pre-set volume.

14. The method of claim 10, comprising providing an indication when the sample is ready for analysis.

15. The method of claim 14, comprising providing the indication based on one or more indication conditions.

16. The method of claim 15, wherein one or more indication conditions comprise the sample settling for a pre-set settling duration.

17. The method of claim 10, comprising determining one or more timing parameters for controlling sample collection based on a pre-defined schedule.
